(19) United States
(12) Patent Application Publication
(10) Pub. No.: US 2010/0174712 A1
(43) Pub. Date: Jul. 8, 2010

(54) EXPERTISE RANKING USING SOCIAL DISTANCE

(75) Inventors: Boxin Li, Sammamish, WA (US); Dmitriy Meyerzon, Bellevue, WA (US); Yauhen Shnitko, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/349,518

(22) Filed: Jan. 7, 2009

(51) Int. Cl. G06F 7/06; G06F 17/30

(52) U.S. Cl. 707/736; 707/E17.014; 707/E17.044; 707/802

(57) ABSTRACT

Tools and techniques for expertise ranking using social distance are provided. These tools may receive search queries from users, and extract from these search queries record identifiers associated with the users. In addition, the tools may extract query strings from the search queries. In connection with processing these queries, the tools may identify other users associated with a given user, with some of these other users being first-level colleagues of a given user, and some of these other users being second-level colleagues. The tools may identify documents within a search store that are associated with the other users, and may search these documents for any occurrences of the query string. In turn, results of the search may be ranked based on a social distance between the user and the other users, with the social distance indicating whether the other users are first-level or second-level colleagues of the user.

### BACKGROUND

Within a typical corporate enterprise, personnel within that enterprise may possess particular skills or expertise. Conventional search engines are typically configured to index documents to facilitate keyword searching. Although these previous search engines may be effective for keyword searching, these search engines may not be as effective in indexing user profiles and ranking users as search results relating to their expertise.

### SUMMARY

Tools and techniques for expertise ranking using social distance are provided. These tools may receive search queries from users, and extract from these search queries record identifiers associated with the users. In addition, the tools may extract query strings from the search queries. In connection with processing these queries, the tools may identify other users associated with a given user, with some of these other users being first-level colleagues of a given user, and some of these other users being second-level colleagues. The tools may identify documents within a search store that represent the other users, and may search these documents for any occurrences of the query string. In turn, results of the search may include representations of these other users, responsive to the query string. These search results may be ranked based on a social distance between the user and the other users, with the social distance indicating whether the other users are first-level or second-level colleagues of the user.

It should be appreciated that the above-described subject matter may be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a combined block and flow diagram illustrating systems or operating environments suitable for implementing tools and techniques related to expertise ranking using social distance.

FIG. 2 is a block diagram illustrating examples of first-level and second-level colleague relationships between different users.

FIG. 3 is a block diagram illustrating inverted indexes that store representations of colleague relationships between different users.

FIG. 4 is a combined block and flow diagram illustrating document and record identifiers that may be associated with different users who are in a colleague relationship, as well as illustrating anchor text and colleague links may associate documents with different users to facilitate efficient searches.

FIG. 5 is a flow diagram illustrating process flows related to processing profile stores in connection with expertise ranking using social distance.

FIG. 6 is a flow diagram illustrating process flows related to processing queries in connection with expertise ranking using social distance.

### DETAILED DESCRIPTION

The following detailed description provides tools and techniques for expertise ranking using social distance. While the subject matter described herein presents a general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

The following detailed description refers to the accompanying drawings that form a part hereof, and that show, by way of illustration, specific example implementations. Referring now to the drawings, in which like numerals represent like elements through the several figures, this description provides various tools and techniques for expertise ranking using social distance.

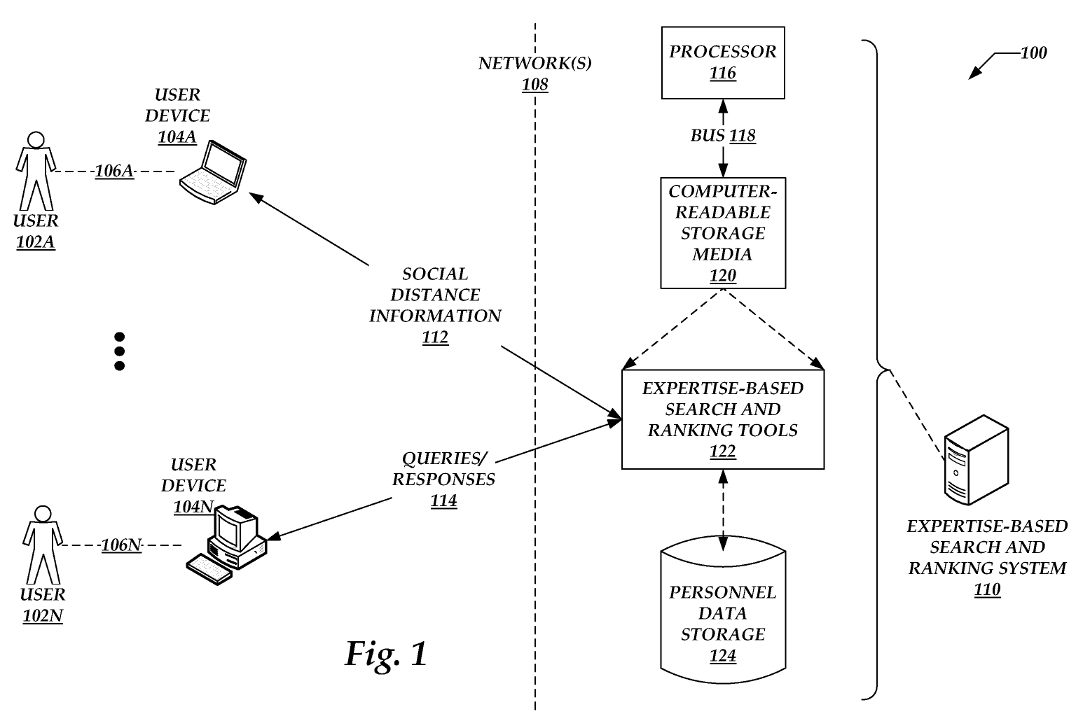

FIG. 1 illustrates systems or operating environments, denoted generally at 100, suitable for implementing expertise ranking using social distance. Turning to FIG. 1 in more detail, any number of users 102a and 102n (collectively, users 102) may interact with corresponding user devices 104a and 104n (collectively, user devices 104). FIG. 1 represents these interactions respectively at 106a and 106n (collectively, interactions 106). In general, these interactions 106 may denote commands issued by the users to the devices 104, responses to these commands, and the like, in connection with expertise ranking using social distance.

To facilitate the interactions 106, the user devices 104 may communicate over one or more networks 108 with one or more expertise-based search and ranking systems 110. More specifically, a given user device 104a may communicate social distance information 112 to a profile store 113 that is external to the search and ranking system 110. In turn, the search and ranking system 110 may traverse the profile store 113 to gather the social distance information 112 as provided by the users 102. As described in further detail below, the search and ranking system 110 may process and index the social distance information 112 for subsequent searches.

As also shown in FIG. 1, another given user device 104n may perform searches 114 against search and ranking system 110. For example, these searches 114 may seek particular persons having expertise in some area of interest to the users 102. The social distance information 112 as indexed into the search and ranking system 110 may be used to rank the list of persons generated in response to the queries or searches 114. This ranking may be based on, among other factors, the social distance between such persons and the user 102n who ran the search or submitted the query. FIG. 1 generally represents these searches and any responses thereto at 114. However, in providing the examples shown in FIG. 1, it is noted that implementations of this description may enable any number of users 102 and user devices 104 to communicate social distance information to and/or from the search and ranking systems 110. In addition, any number of users 102 and user devices 104 may direct queries to the search and ranking systems 110, and may receive responses thereto.

As discussed in further detail throughout this description, social distance information refers to colleague relationships existing between two or more different users 102. For example, from the perspective of a given user 102, this description refers to any colleagues of that given user as “first level” colleagues. Extending the colleague concept further, any colleagues of these first level colleagues are referred to as “second level” colleagues of the given user 102. These different first and second level colleagues may possess particular expertise as to subject matter of interest to the given user 102. In some cases, these colleagues may hold positions of responsibility or authority within a given organization or enterprise that includes the given user 102. For example, the given user 102 may be interested in particular expertise in connection with discharging his or her daily duties.

The term “social distance” between a first user and a second user, as that term appears within this description, may refer to how many degrees of separation exist in any relationship between these users. For example, if these users are colleagues of one another and thus have some degree of social trust or familiarity with one another, than these users may be described as “first-level” colleagues. As another example, if these two users are linked to one another by a colleague who is common to both users, then these two users may be described as “second-level” colleagues.

Second-level colleagues may or may not have the same degree of social trust or familiarity with one another as would first-level colleagues. However, by definition, these second-level colleagues share at least one first-level colleague. Therefore, the second-level colleagues may benefit from any trust or familiarity gained by their common first-level colleague. In other words, assume that John and James do not know each other personally, but do share Bob as a common colleague. However, if John thinks highly of their common colleague Bob, John may transfer to James (consciously or subconsciously) at least some of the regard that John holds for Bob. For example, John's thought process might be: “I don't know James personally, but I like and trust my friend Bob, and if Bob likes James, that's good enough for me”.

This description refers to first-level and second-level colleague relationships only for clarity in providing this description, but not to limit possible implementations. For example, implementations of this description may support third-level colleagues, fourth-level colleagues, and so on, without departing from the scope and spirit of this description.

In example implementations, the search and ranking system 110 may enable the given user 102 to locate colleagues having this particular expertise. More specifically, the search and ranking system 110 may enable the given user to find first-level colleagues or second-level colleagues having this particular expertise. The given user may have a social trust relationship with his or her first-level or second-level colleagues. This social trust relationship may make these first-level or second-level colleagues more relevant to the given user, as compared to arbitrary other users with whom the given user has no personal relationship.

Turning to the networks 108 in more detail, these networks 108 may represent one or more communications networks. For example, the networks 108 may represent local area networks (LANs), wide area networks (WANs), and/or personal area networks (e.g., Bluetooth-type networks), any of which may operate alone or in combination to facilitate expertise ranking using social distance. the networks 108 as shown in FIG. 1 also represents any hardware (e.g., adapters, interfaces, cables, and the like), software, or firmware associated with implementing these networks, and may also represent any protocols by which these networks may operate.

Turning to the search and ranking systems 110 in more detail, these systems 110 as shown in FIG. 1 may represent any number of such systems. The search and ranking systems 110 may cooperate with any number of user devices 104 in connection with expertise ranking using social distance. For example, the search and ranking systems 110 and the user devices 104 may cooperate in a client-server relationship, a peer-to-peer relationship, or any other suitable relationship as appropriate for different implementations.

Turning to the systems 110 in more detail, these systems may include one or more processors 116, which may have a particular type or architecture, chosen as appropriate for particular implementations. The processors 116 may couple to one or more bus systems 118 chosen for compatibility with the processors 116.

The search and ranking systems 110 may also include one or more instances of computer-readable storage medium or media 120, which couple to the bus systems 118. The bus systems 118 may enable the processors 116 to read code and/or data to/from the computer-readable storage media 120. The media 120 may represent apparatus in the form of storage elements that are implemented using any suitable technology, including but not limited to semiconductors, magnetic materials, optics, or the like. The media 120 may include memory components, whether classified as RAM, ROM, flash, or other types, and may also represent hard disk drives.

The storage media 120 may include one or more modules of instructions that, when loaded into the processor 116 and executed, cause the systems 110 to perform various techniques related to expertise ranking using social distance. As detailed throughout this description, these modules of instructions may also provide various tools or techniques by which the systems 110 may provide the tools and techniques for expertise ranking using social distance, using the components, flows, and data structures discussed in more detail throughout this description. For example, the storage media 120 may include one or more software modules that implement search and ranking tools 122. These search and ranking tools and 22 generally represent software programmed or configured to perform various functions allocated herein to the systems 110.

The storage media 120 may also contain one or more instances of storage elements 124, which may contain for example personnel data representing a plurality of the users 102. Accordingly, subsequent description may refer to the storage elements 124 as personnel data storage 124. Subsequent drawings elaborate further on the personnel data storage 124. However, in overview, the personnel data storage 124 as shown in FIG. 1 generally represents storage locations for data structures representing, for example, organizational relationships between a plurality of different users 102.

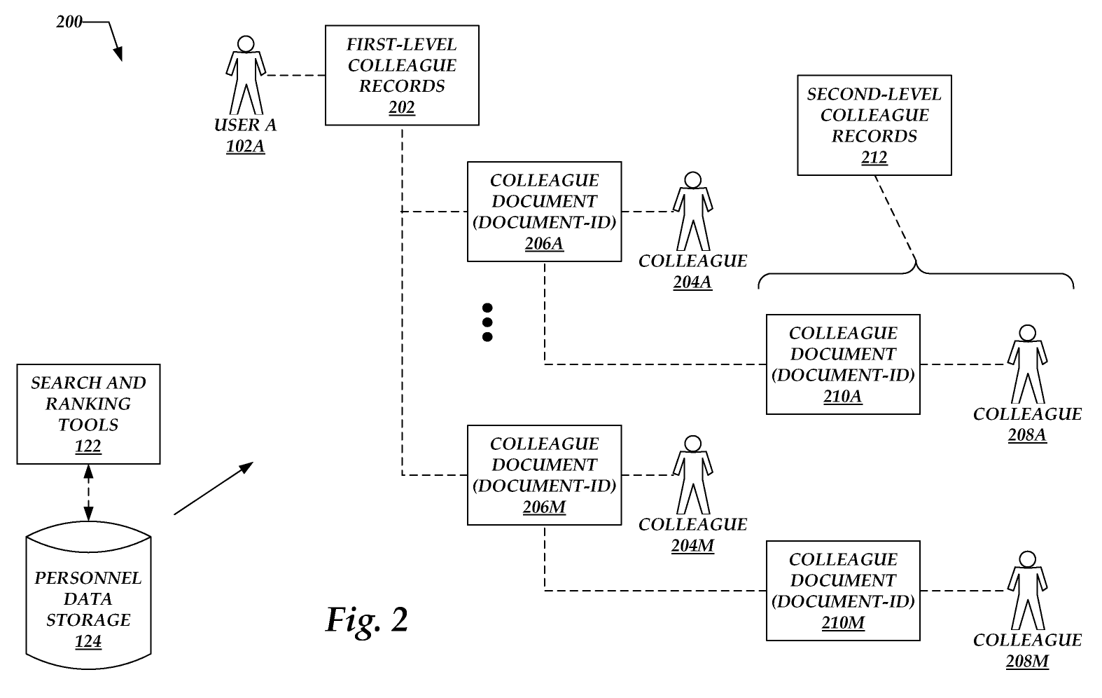

FIG. 2 illustrates examples, denoted generally at 200, of first-level and second-level colleague relationships between different users. For the purposes of this description, but not to limit possible implementations, examples 200 shown in FIG. 2 may be understood as elaborating further on the search and ranking tools 122 and the personnel data storage 124 discussed above with FIG. 1.

Turning to FIG. 2 in more detail, the tools 122 and/or data storage 124 may associate a given user 102a with any number of first-level colleagues, as represented generally by first-level colleague records 202. In the example shown in FIG. 2, the user 102a is associated with at least two first-level colleagues 204a and 204m (collectively, first-level colleagues 204). The colleague records 202 may thus include colleague documents 206a and 206m (collectively, colleague documents 206) that correspond selectively to the colleagues 204a and 204m. In addition, these colleague documents may be associated with respective unique identifiers, as indicated by the text “document-ID” appearing in the labels of blocks 206a and 206m as shown in FIG. 2.

In some cases, different ones of the first-level colleagues 204 may themselves be associated with further first-level colleagues. FIG. 2 illustrates examples of such relationships, with the first-level colleague 204a being associated with at least one first-level colleague 208a and the first-level colleague 204m being associated with at least one first-level colleague 208m. In addition, these first-level colleagues 208a and 208m may be represented by respective instances of colleague documents 210a and 210m (collectively, colleague documents 210).

From the perspective of the colleagues 204, the colleagues 208a and 208m are themselves first-level colleagues. However, from the perspective of the user 102a, the colleagues 208a and 208m are second-level colleagues. Accordingly, this description may refer to the colleagues 208a and 208m collectively as first-level colleagues or second-level colleagues, depending on the context of the reference. In turn, the first-level colleague records 202 may be associated with second-level colleague records 212, with FIG. 1 representing this association by the dashed line 214.

As shown in FIG. 2, different given users 102 may be part of interconnected networks of colleagues, with different users 102 assuming different colleague relationships with other users. For example, the user 102a may himself or herself be a first-level or second-level colleague of other users 102 (not shown in FIG. 2). In addition, the colleagues 204 and 208 may themselves be users who in turn are associated with further networks of colleagues. Accordingly, it will be appreciated that the scenario shown in FIG. 2 is a relatively simplified example presented only for the convenience of description and illustration. However, implementations of this description may include colleague networks of arbitrary complexity and depth, including any number of users in any suitable colleague relationships.

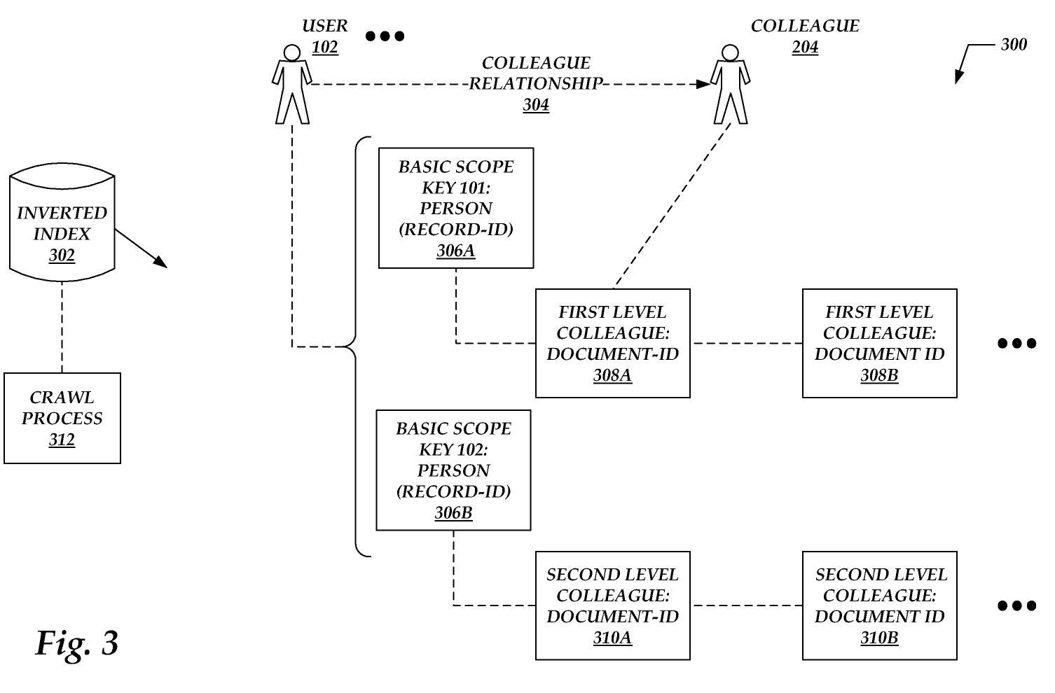

FIG. 3 illustrates inverted indexes 302 that store representations 304 of colleague relationships between representative users 102 and representative colleagues 204. A given user 102 may be represented in the inverted index 302 by one or more person records 306a and 306b. The person records 306a may contain a basic scope key that is associated with a list of first-level colleagues for that user 306a. For example, a prefix “101” as shown in FIG. 3 may indicate that the person record 306a is associated with the list of first-level colleagues.

Implementations of this description may utilize basic scope keys because unlike regular keys in an inverted index, basic scope keys do not store occurrence information. However, implementations of this description may not utilize occurrence information. Therefore, using scope keys rather than regular keys may provide these implementations with a significant performance advantage.

Any number of these first-level colleagues may be represented by respective documents 308a and 308b (collectively, first-level documents 308). For example, a representative colleague 204 may be represented by the document 308a.

The person records 306b may contain a basic scope key that is associated with a list of second-level colleagues. For example, a prefix “102” as shown in FIG. 3 may indicate that the person record 306b is associated with the list of second-level colleagues.

Any number of these second-level colleagues may be represented by respective documents 310a and 310b (collectively, second-level documents 310). For example, a colleague of the representative colleague 204 may be represented by the document 310a.

A crawl process 312 may populate the inverted index 302 with the information represented generally in FIG. 3. In general, persons are represented by document IDs within the inverted index 302. For example, a first person A may have a first-level colleague, person B. Thus, the crawl process 312 may view this colleague relationship as a document A (representing person A) having a colleague link to a document B (representing person B). This colleague link may be represented by the anchor text “[101]<person A record id>”.

Turning to the colleague links in more detail, these links indicate colleague relationships between different users. Once the first and second level colleague all of the colleagues are known, the basic scope index key may be created. Thus, these keys may be built similarly to indexing anchor text. Once all documents that reference a given document are known, keys for the anchor text within that given document may be created. The crawl process, therefore, may include two stages: a first stage discovering all documents (or user records), and a second stage indexing all anchor text (user colleague information). The second stage may start only after the first stage has completed fully.

In turn, the person B may have a first-level colleague, person C. Assuming that this first-level relationship is public, the crawl process 312 may view this colleague relationship as document A having a colleague link to a document C (representing person C). This colleague link may be represented by the anchor text “[102]<person A record id>”.

In cases where the colleague relationship between person B and person C is private, then the second-level colleague link between documents A and C would not exist. However, the first-level colleague link between documents B and C would exist nevertheless.

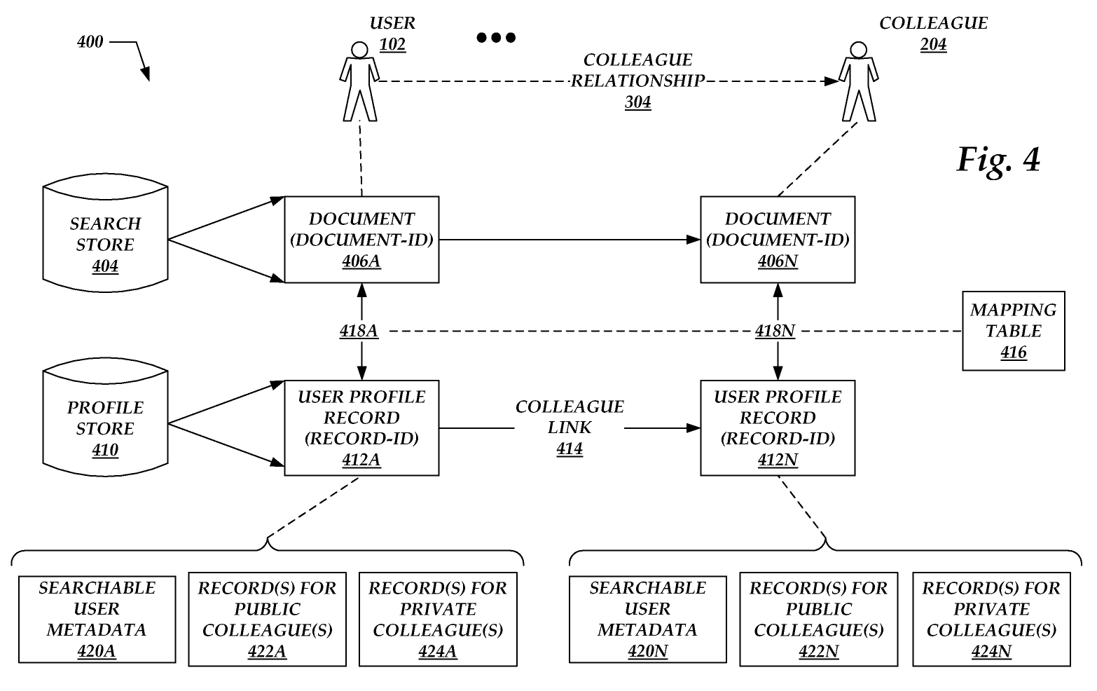

In light of the foregoing illustrative document representations, the crawl process 312 may discover the colleague relationship between persons A and B as “record id A”→“record id B”. However, the crawl process 312 may store this colleague relationship in the inverted index 302 as “[101]Record id A”→“document id B”. Therefore, the crawl process 312 may utilize a mapping table as described further below in FIG. 4.

FIG. 4 illustrates document and record identifiers, denoted generally at 400, that may be associated with different users 102 and 204 who are in a colleague relationship 304. A searchable store 404 may include documents 406a and 406n (collectively, documents 406) that respectively represent the users 102 and 204. In addition, the documents 406 may be associated with unique identifiers (e.g., as indicated by the “document-ID” label shown in the blocks 406a and 406n). These unique identifiers may facilitate searching for and extracting the individual documents 406 by serving as search keys.

A profile store 410 may include any number of user profile records, with FIG. 4 illustrating an example user profile record 412a associated with the user 102 and an example user profile record 412n associated with the colleague 204. The user profile records 412 and 412n (collectively, user profile records 412) may be indexed with suitable unique identifiers, as indicated by the “record-ID” labels shown in the blocks 412a and 412n.

The user profile records 412 may represent the colleague relationship 304 between the users 102 and 204 by incorporating a colleague link 414 between the user profile records 412a and 412n. An analogy can be drawn between the colleague relationship 304 and the colleague link 414. Given the two users 102 and 204 in a colleague relationship, the search store 404 may represent these two users by the documents 406a and 406n, and the profile store 410 may represent these users by the user profile records 412a and 412n. Accordingly, the colleague relationship 304 between the users 102 and 204 (where the user 204 is in a colleague list associated with the user 102) may be modeled by the user profile record 412a having the colleague link 414 pointing to the user profile record 412n. In this scenario, the link text may be the “record-ID” of the user profile record 412a.

Assuming that the profile store 410 provides an inverted search index (e.g., 302 in FIG. 3), a search index may store the “record-ID” of the user 102 as a basic scope key to the list of “document-IDs” that represent the list of colleagues associated with the user 102, which colleague list may include at least the user 204. The anchor text 408 in the document 406a may be used as a key to look up the “document-ID” of the document 406n in the inverted index (e.g., for recall/ranking purposes). Similarly, the colleague link 414 may enable the “record-ID” to serve as a key to look up the “record-ID” of the user profile record 412n that is associated with the colleague 204. Typically, lookup operations using index keys are relatively efficient, so using the index to store and represent the colleague relationships 304 may enable efficient identification of the colleagues 204 associated with a given user 102.

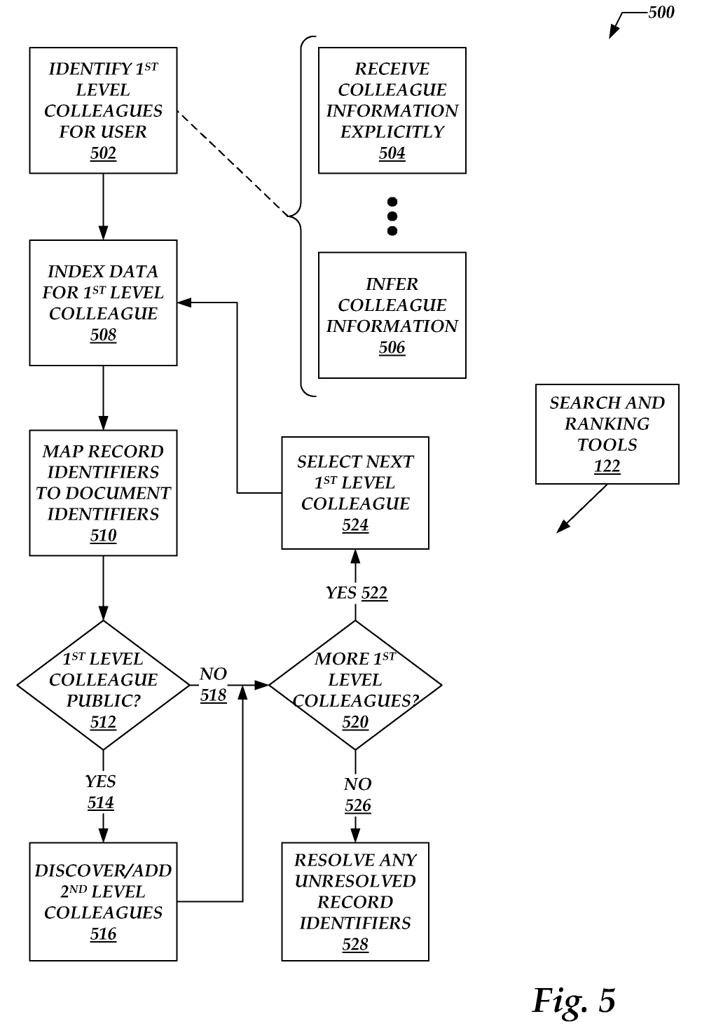

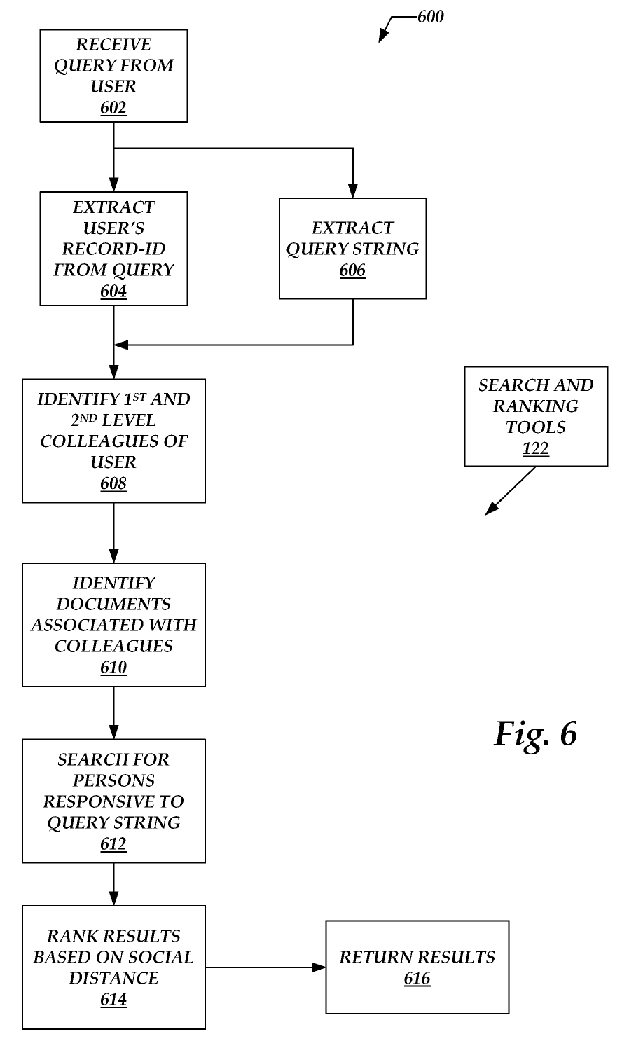

As shown in FIG. 4, a mapping table 416 may relate or map document-IDs to record-IDs, and vice versa. This mapping process is described further below with FIGS. 5 and 6, in connection with certain process flows related to expertise ranking using social distance. More specifically, a mapping 418a may relate the document-ID of the document 406a to the record-ID of the user profile record 412a, and a mapping 418n may relate the document-ID of the document 406n to the record-ID of the user profile record 412n. For example, certain operations may output document-IDs, while other operations expect input in the form of record-IDs. The mappings 418a and 418n (collectively, mappings 418) may promote compatibility between such processes.

The user profile records 412 may store various information related to particular users. For example, the user 102 may be associated with the user profile record 412a, while the colleague or user 204 may be associated with the user profile record 412n. Turning to the user profile record 412a in more detail, it may include searchable metadata associated with the user 102, with this metadata represented generally at 420a. This metadata 420a may include any searchable information related to a given user 102 that is of potential interest to other users 102. Examples of this metadata 420a may include, but is not limited to, names, titles e-mail addresses, office numbers, lists of public or private colleagues, memberships in forums or discussion groups, biographical information, phone numbers, identifications of managerial or supervisory personnel, pictures, work history, past projects, particular areas of responsibility, skills or training, organization memberships, and the like.

In example implementations, the crawl process 312 shown in FIG. 3 may retrieve this metadata 320 as stored into the search store 404. Thus, when serving a given query, the search system may service this query from the search store 404, rather than accessing the external profile store 410.

In particular, the metadata 420a may indicate particular skills, expertise, background, or talent that a given user may possess. The tools and techniques disclosed herein may index the metadata (including metadata representing such skills, expertise, and the like) to facilitate searches that attempt to locate the given user. More specifically, as described in further detail below, input queries may reference particular skills or expertise to locate particular users possessing such skills or expertise.

The user profile record 412a may include records 422a indicating any public colleagues associated with the user 102. The term “public colleagues” as used herein refers to a scenario in which a first-level colleague is associated with additional colleagues. These additional colleagues may be “public” colleagues, in the sense that the first-level colleague may expose the additional colleagues to other users who are discovering second-level colleagues. Put differently, public first-level colleagues are eligible to become second-level colleagues indirectly for other users.

The user profile record 412a may also include records 424a indicating any private colleagues associated with the user 102. The term “private colleagues” as used herein refers to a scenario in which a first-level colleague reveals the existence of the additional colleagues referred to above. In these latter scenarios, these additional colleagues are “private” colleagues, in the sense that the first item level colleague does not expose the additional colleagues to other users who are discovering second-level colleagues. Put differently, private and first-level colleagues are ineligible to become second-level colleagues.

Referring to the user profile record 412n, this record may include searchable metadata 420n that is associated with the user 204, who is also a first-level colleague of the user 102. In addition, the user profile record 412n may also include records 422n for any public colleagues, and may include records 424n for any private colleagues. From the viewpoint of the user 102, any public colleagues of the first-level colleague 204 (as represented in the records 422n)are eligible to become second-level colleagues of the user 102, while any private colleagues of the first-level colleague 204 (as represented in the records 424n) are in eligible to become second-level colleagues of the user 102.

FIG. 5 illustrates processes, denoted generally at 500, related to processing profile stores in connection with expertise ranking using social distance. FIG. 4 provides an example of a profile store at 410. Without limiting possible implementations, the processes 500 may be understood as elaborating on processes performed by the search and ranking tools 122 shown in FIG. 1. In addition, the processes 500 may be referred to as “crawling” the profile store.

Turning to the processes 500 in more detail, block 502 represents processing a given user to identify first-level colleagues of the given user. For example, referring briefly back to the user 102a shown in FIG. 2, the users 204a and 204m are first-level colleagues of the user 102a. Accordingly, block 502 may include processing the user profile records (e.g., 412 in FIG. 4) for the given user, and populating the public or private colleague records for that user (e.g., 422 and 424 in FIG. 4).

As shown in FIG. 5, block 502 may include receiving colleague information directly and explicitly from a given user. For example, the search and ranking tools 122 may conduct an interactive dialogue with the given user, during which the given user may supposedly specify or identify his or her first-level colleagues.

In other scenarios, represented generally at 506, block 502 may include inferring colleague information for the given user. For example, block 506 may include inferring colleague information by analyzing a representation of an organization chart, reporting hierarchy, or other structure representation of personnel relationships. In some cases, block 506 may include presenting this inferred colleague information to the given user for approval, editing, rejection, or other suitable disposition.

Block 508 represents indexing data or information for any first-level colleagues identified in block 502, in cases where this information is not already indexed. Block 508 may also include indexing information for the given user, if this information is already indexed. Put differently, block 508 may include and represent building the data structures and associations shown in FIGS. 2 and 3.

Block 510 represents mapping any record identifiers (e.g., “record-IDs” discussed above) to document identifiers (e.g., “document-IDs” discussed above) for the given user and any first-level colleagues located in block 502. For example, block 510 may include populating the mapping table 416 shown in FIG. 4 with mapping entries such as those shown at 418a and 418n.

In many cases, it may not be immediately possible fully to map document and record identifiers associated with newly discovered first-level colleagues. In these scenarios, these newly discovered first-level colleagues may not have had their information fully resolved. Accordingly, block 510 may include marking or otherwise indicating any unresolved records associated with first-level colleagues for later resolution.

Decision block 512 represents evaluating whether a given first-level colleague is a public colleague or a private colleague. If the given first-level colleague as a public colleague, the process flows 500 may take Yes branch 514 to block 516. Block 516 represents discovering and adding any colleagues of this public first-level colleague as second-level colleagues on the given user.

Returning to decision block 512, if the given first-level colleague is a private colleague, the process flows 500 may take No branch 518 to decision block 520. In effect, No branch 518 bypasses processing block 516, such that the process flows 500 do not discover any second-level colleagues through the given first-level colleague.

Decision block 520 represents evaluating whether any more first-level colleagues of the given user remain to be processed. From decision block 520, if more first-level colleagues remain to be processed, the process flows may take Yes branch 522 to block 524. Block 524 represents selecting a next first-level colleague for processing. Afterwards, the process flows 500 repeat blocks 508-520 for this next first-level colleague.

Returning to decision block 520, if no more first-level colleagues remain for processing, the process flows 500 may take No branch 526 to block 528. Block 528 represents resolving any previously unresolved record or document identifiers or other parameters associated with first-level or second-level colleagues. For example, block 528 may represent mapping record identifiers to document identifiers and vice versa, among other functions.

As described above, the process flows 500 may be referred to as profile “crawl” processes. In some cases, these profile crawl processes may be “full” processes, in which an entire profile store (e.g., 410 in FIG. 4) is traversed, analyzed, and processed. In other cases, these profile crawl processes may be “incremental” processes, which process and analyze only those portions of the profile store that have changed since the last incremental or full crawl. Accordingly, it is noted that the process flows 500 may be adapted as appropriate for incremental or full crawls in different operational scenarios. For example, an incremental crawl operation may perform only certain portions of the process flows 500 for those areas of the profile store that have changed since the last crawl.

In addition, it is noted that the crawl processes represented in FIG. 5 may be repeated automatically, or may be triggered manually, as appropriate in different implementation scenarios. In an operational environment, for example, different users may gain or lose first-level colleagues over time. Referring to FIG. 2, a given user 102a may lose his or her first-level colleague 204m for any number of reasons. Once the given user 102a has lost that first-level colleague 204m, the user 102a may also lose any second-level colleagues 208m gained through the lost first-level colleague 204m.

In other scenarios, a given user 102a may lose one or more second-level colleagues (e.g., 208a or 208m as shown in FIG. 2). The given user 102a may lose a second-level colleague with or without necessarily losing the corresponding first-level colleague (e.g., 204a or 204m, respectively).

In still other scenarios, the given user 102a may gain one or more additional first-level colleagues (e.g., 204a, 204m, or the like). If such new first-level colleagues are further associated with their own first-level public colleagues, the given user 102a may gain new second-level colleagues through these new first-level colleagues. In addition, new or existing first-level colleagues may gain additional colleagues, with these additional colleagues possibly being eligible to become second-level colleagues of the given user 102a.

The foregoing examples, and possibly other examples omitted from this description the interest of conciseness, illustrate the general proposition that changes to first-level or second-level colleagues may have ripple effects or consequences within the list or network of colleagues maintained for a given user. However, the incremental crawl processes as shown in FIG. 5 may update the list or network of colleagues to accommodate the results of any such changes.

FIG. 6 illustrates process flows, denoted generally at 600, related to processing queries in connection with expertise ranking using social distance. Without limiting possible implementations, the process flows 600 may be understood as elaborating further on processing performed by the search and ranking tools 122.

Turning to the process flows 600 in more detail, block 602 represents receiving a given query from a given user. This input query may include or incorporate a unique identifier associated with the given user. Examples of suitable unique identifiers include, but are not limited to, the above record-ID identifiers described. However, implementations of this description may operate with other types of identifiers without departing from the scope and spirit of this description.

In addition, the input query may include a query string sought by the given user. Examples of this query string may include descriptions of particular expertise, knowledge, or skills in which the given user is interested at a given time. Using the tools and techniques described herein, given user may be able to query for and identify those colleagues who possess the desired expertise, knowledge, or skills.

Block 604 represents extracting from the input query the unique identifier or other information that indicates which user is submitting a query. As described above, the record-ID identifier discussed in this description provides a non-limiting example.

Block 606 represents extracting the query string from the input query. For convenience of illustration only, FIG. 6 illustrates blocks 604 and 606 proceeding in parallel. However, it is noted that the processing represented by these blocks 604 and 606 may proceed in any suitable relationship relative to one another in possible implementations.

Block 608 represents identifying first and second level colleagues associated with the user who submitted a query. For example, referring to the colleague network shown in FIG. 2, and assuming that the user 102a submits a query, block 608 may include identifying any first-level colleagues (e.g., 204a and 204m) associated with the user submitting the query. Block 608 may also include identifying any second-level colleagues (e.g., 208a and 208m) associated with this user.

Turning to block 608 in more detail, and referring briefly to the data structures as shown in FIG. 4, block 608 may include searching an index associated with the profile store 410, using the user's record-ID as a search key (recalling that block 604 extracted this record-ID). Once the appropriate user profile record is located (e.g., 412a in FIG. 4), block 608 may include traversing a suitable colleague link (e.g., 414 in FIG. 4) to access user profile records (e.g., 412n) associated with any first-level colleagues (e.g., 204). Block 608 may be repeated as appropriate to traverse to all first-level colleagues associated with a given user, as well as traversing to any second-level colleagues associated with the given user.

Block 610 represents identifying any searchable documents associated with the first-level and second-level colleagues identified in block 608. Examples of such searchable documents may documents authored by such colleagues. Some implementations may return these documents in response to a given query, while also returning a list of colleagues responsive to the given query.

Block 612 represents searching for any persons whose skills and expertise are responsive to the search string extracted in block 606. For example, assuming that the query string extracted in block 606 pertains to particular skills or experience with a given database, block 612 may include searching for any colleagues whose metadata or other document information indicates experience or skill with that given database.

Block 614 represents ranking any results received from block 612 based on the social distance of any colleagues, considered relative to the user who submitted the query. In some scenarios, block 614 may include ranking first-level colleagues with pertinent skills ahead of second-level colleagues having similar skills. In other scenarios, block 614 may include considering how closely the skills possessed by first-level and second-level colleagues relate to the input query, in addition to considering the social distance between the querying user and these colleagues. Other scenarios are possible, in which the social distance is weighted relatively heavily, relatively lightly, or otherwise as appropriate.

Turning in more detail to the ranking represented in block 614, this ranking may combine a dynamic score (DS) and a social distance score (SD), such that the ranking is represented as the “sum” of DS and SD. The dynamic score DS may represent how well the user profiles for different users correspond to a given set of query terms. For example, if a given user is looking for experts on “ranking”, he or she may submit a query incorporating at least the term “ranking”. In turn, the dynamic scores computed for various other users may indicate how many times the word “ranking” occurs in the expertise fields of these other users. The dynamic score may be computed across any number of relevant textual fields using any suitable ranking function. One possible example of the ranking function is the BM25F ranking function, which is a publicly known algorithm. In general, any textual fields that contain useful or relevant information about the expertise of a given user may be included or considered in the dynamic ranking processes provided herein.

From the perspective of a given user, social distance scores SD may be computed for various other users. More specifically the social distance scores SD may, in example implementations, assume one of three (3) possible values:
a 1^{st} level colleague score (where the other users are first-level colleagues of the given user);
a 2^{nd} level colleague score (where the other users are second-level colleagues of the given user); and
a non-colleague score (where the other users are more remotely related to the given user).
   As noted above, implementations of this description may support 3^{rd} level colleagues or higher-level colleagues. User profiles for the various other users may be assigned one of the above three numbers, depending on the social distances between those other users and the given user at hand. The social distance score SD, therefore, does not depend on the terms of a given query, but instead reflects social proximity to a given user.

Block 616 represents returning any results responsive to the input query as received in block 602. The query results returned in block 616 may be ranked, at least in part, based on social distance, as represented in block 614.

The foregoing description provides technologies for expertise ranking using social distance. Although the this description incorporates language specific to computer structural features, methodological acts, and computer readable media, the scope of the appended claims is not necessarily limited to the specific features, acts, or media described herein. Rather, this description provides illustrative, rather than limiting, implementations. Moreover, these implementations may modify and change various aspects of this description without departing from the true spirit and scope of this description, which is set forth in the following claims.

We claim:

1. Apparatus comprising at least one computer-readable storage medium having stored thereon computer-executable instructions that, when loaded into a processor and executed, cause the processor to:
identify at least one colleague relationship between a first user and at least a second user;
associate a first document contained in a search store with the first user;
associate a second document contained in the search store with the second user;
associate the first user with at least a first user profile record; and
associate the second user with at least a second user profile record, wherein the first user profile record includes a colleague link indicating that the second user is a colleague of the first user.

2. The apparatus of claim 1, further comprising instructions to establish a first mapping between the first document and the first user profile record, and to establish at least a second mapping between the second document and the second user profile record.

3. The apparatus of claim 1, further comprising instructions to associate the first document with a first document identifier that uniquely identifies the first user within the search store, and further comprising instructions to associate the second document with a second document identifier that uniquely identifies the second user within the search store.

4. The apparatus of claim 3, further comprising instructions to associate the first user profile record with a first record identifier that uniquely identifies the first user within a profile record store, and further comprising instructions to associate the second user profile record with a second record identifier that uniquely identifies the second user within the profile record store, wherein the colleague link associates the first record identifier with the second record identifier.

5. The apparatus of claim 4, further comprising instructions to:
receive a search query from the first user, wherein the search query references the first record identifier;
search the profile store for the first record identifier;
locate the first user profile record;
identify at least the second record identifier by traversing the colleague link; and
identify at least the second user as a colleague of the first user based on the colleague link.

6. The apparatus of claim 5, further comprising instructions to map the second record identifier to the second document identifier, and further comprising instructions to search the second document for any occurrences of a query string included in the search query.

7. Apparatus comprising at least one computer-readable storage medium having stored thereon computer-executable instructions that, when loaded into a processor and executed, cause the processor to:
receive at least one search query from a user;
extract from the search query a record identifier associated with the user;
extract from the search query a query string;
identify a plurality of other users associated with the user, wherein at least a first one of the other users is a first level colleague associated with the user, wherein at least a second one of the other users is a colleague of the first other user and is a second-level colleague of the user;
identify a plurality of documents within a search store that represent the other users;
search the documents for any occurrences of the query string; and
ranking representations of the other users as results of the search, based on a social distance between the user and the other users, wherein the social distance indicates whether the other users have first-level or second-level colleague relationships with the user.

8. The apparatus of claim 7, further comprising instructions to: compute respective dynamic scores for the other users, wherein the dynamic scores are computed based upon comparisons of the query string to user profiles associated with the other users; compute respective social distance scores for the other users, wherein the social distance scores are based on colleague relationships between the user and the other users, with the ranking of the other users incorporating the dynamic scores and the social distance scores computed for the other users; and return to the user the representations of the other users as search results.

9. The apparatus of claim 7, wherein the instructions to identify the other users include instructions to access a colleague link associating the record identifier of the user with respective other record identifiers associated with the other users.

10. The apparatus of claim 9, further comprising instructions to map the other record identifiers to document identifiers associated with the documents, wherein the documents represent the other users in a search store.

11. The apparatus of claim 7, wherein the instructions to search include instructions to search for the query string in searchable metadata associated with the other users, wherein the searchable metadata relates to expertise associated with the other users, and wherein the query string relates to the expertise.

12. Apparatus comprising at least one computer-readable storage medium having stored thereon computer-executable instructions that, when loaded into a processor and executed, cause the processor to:
traverse a profile store that contains respective personnel records for a plurality of users;
index information contained in a first record within the profile store that is associated with a first one of the users;
analyze the first record to identify at least a second user as a colleague of the first user;
access a colleague link contained within the first record to access at least a second record associated with the second user;
analyzing the second record to identify at least a third user as a colleague of the second user; and
evaluating whether the third user is a public colleague of the second user.

13. The apparatus of claim 12, further comprising instructions to associate at least the second user with the first user in a first-level colleague relationship, and further comprising instructions to associate at least the third user with the first user and a second-level colleague relationship.

14. The apparatus of claim 13, further comprising instructions to associate a second record identifier with the second user, and further comprising instructions to map the second record identifier to a second document identifier that corresponds to a second record in the search store, wherein the second record represents the second user in the search store.

15. The apparatus of claim 14, wherein the instructions to associate the second record identifier is performed after completing traversal of the profile store.

16. The apparatus of claim 12, further comprising instructions to complete at least a first complete traversal of the profile store in a first state, and further comprising instructions to traverse thereafter at least a portion of the profile store, wherein the portion of the profile store is changed relative to the first state.

17. The apparatus of claim 16, further comprising instructions to determine that the portion of the profile store indicates that a profile record associated with the third user has changed, and further comprising instructions to update the profile record associated with the first user in response to the change.

18. The apparatus of claim 12, further comprising instructions to determine that the third user is a public colleague of the second user.

19. The apparatus of claim 18, further comprising instructions to associate the third user with the first user in a second-level colleague relationship.

20. The apparatus of claim 12, further comprising instructions to determine that the third user is a private colleague of the second user, and further comprising instructions to withhold the third user from the first user.
